(19) United States
(12) Patent Application Publication
(10) Pub. No.: US 2007/0166479 A1
(43) Pub. Date: Jul. 19, 2007

(54) Deposition of thin films

(76) Inventors: Robert Drake, Penarth (GB); Avril Surgenor, Cardiff (GB); Sian Beverley Rees, Midland, MI (US); John Hannington, Midland, MI (US); Lesley Ann O'Hare, Cork City (IE); Samantha Reed, Cardiff (GB)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/573,908

(22) PCT Filed: Sep. 30, 2004
(86) PCT No.: PCT/EP04/11359

§ 371 Date: Dec. 18, 2006

(30) Foreign Application Priority Data
Oct. 3, 2003 (GB) 0323295.6

(51) Int. Cl. B05D 5/00; B05D 3/00; H05H 1/00

(52) U.S. Cl. 427/535; 427/256; 427/271

(57) ABSTRACT

A method of applying a patterned thin-film onto a substrate comprising the steps of plasma treating the substrate. Applying a liquid coating material, comprising one or more compounds selected from the group of organopolysiloxane polymers, organopolysiloxane oligomers, siloxane resins and polysilanes, onto the substrate surface, by a soft lithographic printing technique, preferably microcontact printing to form a patterned film thereon. Where required any residual liquid coating material may be removed from the substrate surface. The process does not require the liquid coating material undergo a curing step such as is required in Decal Transfer Microlithography techniques. Any suitable form of plasma treatment may be used to activate the substrate prior to printing.

This invention relates to a method for the deposition of patterned thin films particularly patterned thin films of silicon based materials using printing techniques.

The concept of creating adhesion between an uncoated low surface energy substrate and a liquid, which may involve an initial plasma pre-treatment step prior to the application of a reactive coating, is described in WO 02/098962. The coating materials include, for example, direct process residue, chloro substituted organopolysiloxanes and chlorosilanes and they are preferably applied in vapour form. It is an essential step in WO 02/098962 for the grafted coating material to be subsequently oxidized or reduced preferably using a plasma or corona type treatment. In WO 02/098962 the surface may optionally be plasma treated prior to application of the coating. EP 0302625 describes the treating of a perfluorinated polymeric surface with a plasma generated from a gas to give a plasma treated polymeric surface. A polysiloxane lubricant is subsequently applied onto the surface. EP 0329041 describes the plasma deposition of a layer of silicon containing polymer onto a polymeric surface followed by the application of a polysiloxane lubricant.

US2002/0192385 describes a method of applying a fluoroalkyl-functional organopolysiloxane coating onto polymeric substrates by subjecting the substrate to a physical method such as corona discharge, flaming or glow discharge and then coating the activated substrate with the fluoroalkyl-functional organopolysiloxane to provide a thin layer coating thereof on the substrate surface. U.S. Pat. No. 5,798,146 describes a method of improving the wetting and adhesive properties of a substrate made from a dielectric material by establishing a uniform flux of charged particles within a diffuse glow discharge. The diffuse glow discharge is generated using a single needle shaped electrode terminating in a needle point. The electrode is surrounded by a dielectric tube through which air is directed so that corona or glow discharge at the needle point is immersed in the stream of air which carries the charged particles onto the substrate surface. After treating the surface a material such as a fluoropolymer is applied onto the substrate to form a continuous coating.

The patterning of thin films on substrate surfaces can be a problem in a wide variety of applications; such as for example photolithography a key patterning technique for integrated electrical circuitry. Photolithography is able to apply sub-micron sized patterned features that can serve to template the etching and deposition of other functional thin films used to construct electronic circuitry on e.g. silicon chips. However, the ability to pattern materials in thin-film form in this way is exceptionally expensive and as such is not suitable for low-cost applications. Furthermore, the reliance of this process on projection optics means that it is of limited utility for patterning non-planar substrates e.g. 3-D shapes.

In view of this a variety of so-called soft lithographic processes have been developed to provide alternative printing and patterning techniques, which avoid the problems encountered in the expensive photolithographic techniques. A general review of soft lithographic processes is provided in Xia et al, Angew. Chem. Int. Ed., 1998, vol. 37 page 550. Soft Lithography processes are based on the use of stamps fabricated in elastomeric polymers, particularly siloxane rubbers as means of transferring patterns using printing techniques (Kumar et al, Langmuir 1994, vol. 10, p 1498), embossing techniques (Chen et al, Eur Phys J Appl Phys 2000, Vol. 12, p 223) and moulding techniques (Kim et al, J. Am. Chem. Soc. 1996, Vol. 118, p 5722).

Specific soft lithographic techniques include micro-contact printing (μCP) in which a patterned stamp coated with a material to be patterned, generally referred to as “the ink” is simply placed in contact with the substrate. Pattern transfer relies upon a controlled contact mechanism and as such easily creates both continuous and discrete patterns. μCP has been used in a number of applications including the preparation of self-assembled monolayers (SAMs) of alkanethiolates on gold, silver and copper and of alkylsiloxanes on OH− terminated surfaces. Xia et al (Angew. Chem. Int. Ed., 1998, vol. 37 page 559) teach that systems of siloxanes on OH terminated surfaces tend to result in disordered SAMs and in some cases sub-monolayers or multilayers. A number of problems are associated with μCP; for example, the inks are prone to reactive spreading which can affect the resolution of the pattern transfer.

Micro moulding in capillaries (MIMIC) utilizes a siloxane rubber stamp to form capillaries when placed in contact with a substrate. Whilst in contact the channel system created is filled with a liquid prepolymer which is subsequently cured. After curing the mould is peeled away to reveal patterns formed in a variety of substances such as ceramics metals and polymers. MIMIC however requires a number of features which inhibit its usefulness. These include the need for a precursor having a viscosity appropriate for filling the mould in situ, a continuous pattern to allow filling of the mould and an array of discrete patterns requires the use of a 3-D channel system to fill the mould which is impractical for small high feature density patterns. Elastomeric membrane patterning (EMP) uses a thin siloxane rubber membrane stencil-mask as a layer to mediate both additive and subtractive processing. In this technique seemingly the biggest problem needing to be overcome is the inherently mechanical instability of the required membranes. Other techniques, which have been developed, include Replica moulding (REM), Micro-Transfer moulding (μTM) and solvent-assisted micro moulding (SAMM).

Decal Transfer Microlithography (DTM) a process described in Childs et al, J Am. Chem. Soc. 2002, vol. 124, p 13583 is a further soft lithographic patterning technique directed to forming patterned siloxane based coatings on substrates. The method is exemplified by sealing cured siloxane materials to substrates such as silicon, glass, quartz, siloxane rubber and silicon thermal oxide substrates. A liquid siloxane rubber is cast upon a master mould (hereafter referred to as a “master”), cured, extracted from the master and washed and dried to form a moulded siloxane rubber stamp. The surface of the resulting moulded siloxane rubber stamp, which is subsequently to be brought into contact with the substrate surface, is then modified by exposure to UV/ozone for 2.5 minutes at a distance of 1 mm from a mercury bulb and is then immediately brought into contact with a pre-cleaned substrate. The sample and substrate are then heated in an oven at 70° C. for at least 20 minutes. During this extended period at elevated temperatures good bonding between substrate and stamp is said to occur. However, it is admitted that exposure distance, duration and aging between exposure and substrate contact all have negative effects in the bonding process. After the bonding process has been completed the moulded siloxane rubber stamp is physically peeled away from the substrate leaving a pattern thereon which is reliant on the previous development of bonding between the stamp and the substrate, non-bonding of a region of the patterned stamp would seemingly result in the non-transfer of pattern to the equivalent region of the substrate.

The siloxane rubber layers obtained are of variable thickness depending on the size of the bonded area and are much thicker than those obtained using the coating processes of the present invention as will be seen below. This process would appear to be time consuming and requires very specific adhesion steps in order to obtain adhesion between the substrate surface and PDMS. Hence, this process is not able to apply liquid siloxanes or the like onto substrate surfaces to form thin film patterned substrate surfaces.

Hence, it can be seen from the prior art that the provision of patterned thin films has not been successfully achieved in a simple and reproducible manner. The inventors have been unable to locate any prior art, which discusses the successful printing of preformed siloxane polymers. The inventors believe that they have developed a simple method, which solves at least some of the problems, which are identified in the prior art.

In accordance with the present invention there is provided a method of applying a patterned thin-film onto a substrate surface comprising the steps:
i) plasma treating the substrate
ii) applying a liquid coating material, comprising one or more compounds selected from the group of organopolysiloxane polymers, organopolysiloxane oligomers, siloxane resins and polysilanes, onto the substrate surface, by a soft lithographic printing technique, to form a patterned film thereon; and
iii) where required, removing residual liquid coating material from the substrate surface;
   which process does not require the liquid coating material to undergo a curing step.

The soft lithographic technique used in the process of the present invention may be selected from μCP, MIMIC EMP, REM, μTM and SAMM but μCP is preferred technique. Preferably the thin film resulting from the application of the organopolysiloxane onto the substrate is in the region of from 1 to 100 nm in thickness. The thin film may, at least partially, be a self-assembled monolayer.

Any plasma generating-equipment suitable for treating a substrate to be used in the process according to the present invention may be utilised. The choice of plasma source will generally be dictated by the dimensions of the substrate, with glow discharge type sources being used for thin films or plates and other more appropriate systems being used for three dimensional substrates. Preferably non-thermal equilibrium or non-thermal, non-equilibrium plasma equipment may be used to undertake step (i) of the method of the present invention. Suitable non-thermal equilibrium plasmas which may be utilised for the present invention include, atmospheric pressure glow discharge, dielectric barrier discharge (DBD), low pressure glow discharge, so called plasma knife type equipment (as described in WO 03/085693) or post discharge plasma, which may be operated in either continuous mode or pulse mode are particularly preferred. Preferred processes are “low temperature” plasmas wherein the term “low temperature” is intended to mean below 200° C., and preferably below 100° C. These are plasmas where collisions are relatively infrequent (when compared to thermal equilibrium plasmas such as flame based systems) which have their constituent species at widely different temperatures (hence the general name “non-thermal equilibrium” plasmas).

Post discharge plasma systems have been developed to produce plasmas using gases passing between adjacent and/(or coaxial) electrodes at high flow rates. These gases pass through the plasma region defined by the shape of the electrodes and exit the system in the form of excited and/or unstable gas mixtures at around atmospheric pressure. These gas mixtures are characterized by being substantially free of electrical charged species, which may be utilized in downstream applications remote from the plasma region, i.e. the gap between the adjacent electrodes in which plasma is generated. This “atmospheric pressure post plasma discharge ” (APPPD) has some of the physical characteristics of low pressure glow discharge and APGD including, for example, glow, presence of active light emitting species and chemical reactivity. However, some clear and unique differences exist including the facts that APPPD has higher thermal energy, absence of boundary walls e.g. no electrodes, substantial absence of electrically charged species, large choice of gases and mixture of gases, large flow rate of gases. Systems of this type are described in U.S. Pat. No. 5,807,615, U.S. Pat. No 6,262,523 and GB 0324147.8 the latter of which was unpublished at the International filing date of the present application.

Suitable alternative plasma sources may for example comprise, microwave plasma sources, corona discharge sources, arc plasmas sources, DC magnetron discharge sources, helicon discharge sources, capacitatively coupled radio frequency (rf) discharge sources, inductively coupled RF discharge sources and/or resonant microwave discharge sources.

Any conventional means for generating an atmospheric pressure glow discharge or post discharge may be used in the method of the present invention, for example atmospheric pressure plasma jet, atmospheric pressure microwave glow discharge and atmospheric pressure glow discharge. Typically, atmospheric pressure glow discharge processes will employ helium as a process gas and a high frequency (e.g. >1 kHz) power supply to generate a homogeneous glow discharge at atmospheric pressure via a Penning ionisation mechanism, (see for example, Kanazawa et al, J Phys. D: Appl. Phys. 1988, 21, 838, Okazaki et al, Proc. Jpn. Symp. Plasma Chem. 1989, 2, 95, Kanazawa et al, Nuclear Instruments and Methods in Physical Research 1989, B37/38, 842, and Yokoyama et al., J. Phys. D: Appl. Phys. 1990, 23, 374).

A typical atmospheric pressure glow discharge generating apparatus for use in the method of the present invention may comprise one or more pairs of parallel or concentric electrodes between which a plasma is generated in a substantially constant gap of from 3 to 50 mm, for example 5 to 25 mm between the electrodes or more preferably between dielectric coatings on the electrodes. The actual distance between adjacent parallel electrodes used, whilst up to a maximum of 50 mm is dependent on the process gas used. The electrodes being radio frequency (RF) energised with a root mean square (rms) potential of 1 to 100 kV, preferably between 1 and 30 kV and most preferably between 2.5 and 10 kV, however the at value will depend on the chemistry/gas choice and plasma region size between the electrodes. The frequency is generally between from 1 to 100 kHz, preferably at 15 to 50 kHz. Alternative atmospheric pressure glow discharge/corona systems suitable for plasma treating the substrate in accordance with the present invention might include single needle shaped electrode system of the type described in U.S. Pat. No. 5,798,146.

The atmospheric pressure glow discharge process gas may be any suitable gas but is preferably a noble gas or noble gas based mixture such as, for example helium, a mixture of helium and argon and an argon based mixture additionally containing ketones and/or related compounds. In the present invention these process gases are utilized in combination with one or more potentially reactive gases suitable for affecting the required oxidation of the liquid precursor such as, for example, O₂, H₂O, nitrogen oxides such as NO₂, or air and the like. Most preferably, the process gas will be Helium optionally in combination with an oxidizing gas, typically oxygen or air. However, the selection of gas depends upon the plasma processes to be undertaken. When an oxidizing gas is present it will preferably be utilized in a mixture comprising 90-99% noble gas and 1 to 10% oxidizing gas.

The low pressure plasma may be performed with pulsing of the plasma discharge, but is preferably carried out without the need for additional heating. The plasma may be generated by way of the electromagnetic radiations from any suitable source, such as radio frequency, microwave or direct current (DC). A radio frequency (RF) range between 8 and 16 MHz is suitable with an RF of 13.56 MHz preferred. In the case of low pressure glow discharge any suitable reaction chamber may be utilized. The power of the electrode system may be between 1 and 100 W, but preferably is in the region of from 5 to 50 W for continuous low pressure plasma techniques. The chamber pressure may be reduced to any suitable pressure for example from 0.1 to 0.001 mbar (10 to 0.1 Pa) but preferably is between 0.05 and 0.01 mbar (5 and 1 Pa).

A particularly preferred plasma treatment process involves pulsing the plasma discharge at room temperature. The plasma discharge is pulsed to have a particular “on” time and “off” time, such that a very low average power is applied, for example a power of less than 10 W and preferably less than 1 W. The on-time is typically from 10 to 10000 μs, preferably 10 to 1000 μs, and the off-time typically from 1000 to 10000 μs, preferably from 1000 to 5000 μs.

In the case of the low pressure plasma, the suitable alternatives for the process gas for forming the plasma are generally as described for the atmospheric pressure system but do not have to comprise noble gases such as helium and/or argon and may therefore purely be oxygen, air or an alternative oxidising or reducing gas. In the case of post discharge atmospheric pressure non-equilibrium plasma a reducing plasma gas mixture may be used, e.g. N₂/H₂ with H₂ being present in an amount of up to 5% by volume, preferably about 3%.

One particular advantage for using the plasma processing step at atmospheric pressure and low temperatures (preferably <100° C. as previously indicated) is the fact that filmic substrates may be plasma treated on a continuous roll by any suitable method but particularly using a reel to reel process. Preferably, the process according to the present invention is a continuous process comprising an initial plasma treating section followed by an automated printing region.

The substrate to be coated may comprise any suitable material, for example metals, metal foils and metal oxides such as indium tin oxide, glass, carbonaceous materials, ceramics, semi-conductor materials such as gallium arsenide, plastics, polymeric silicon containing materials such as cured silicone resins, silsesquioxane materials, organopolysiloxane materials and polysilane oligomers/polymers, woven or non-woven fibres, natural fibres, synthetic fibres cellulosic materials and photoresist materials. The term plastics may mean any suitable thermoset or thermoplastic material such as polyolefins e.g. polyethylene, and polypropylene, polycarbonates, polyurethanes, polyvinyl chloride, polyesters (for example polyalkylene terephthalates, particularly polyethylene terephthalate (PET)), polymethacrylates (for example polymethylmethacrylate and polymers of hydroxyethylmethacrylate), polyepoxides, polysulphones, polyphenylenes, polyetherketones, polyimides, polyamides, polystyrenes, phenolic, epoxy and melamine-formaldehyde resins, and blends, laminates and copolymers thereof.

In a preferred embodiment the organopolysiloxane is applied onto the substrate in the form of an ink as part of a soft lithographic process such as for example μCP, MIMIC, EMP, REM, μTM or SAMIM, although a μCP type process is preferred.

In the case of a μCP process any appropriate type of stamp may be used but polydimethylsiloxane (PDMS) based stamps are preferred. An example of a suitable material for making stamps for the invention in accordance with the present application is SYLGARD® 184 Silicone Elastomer. (Dow Corning Corporation, Michigan, USA) Moulds to be used in the process are prepared by making the polymeric material to be used in the mould and pouring a sufficient amount of it into a master mould. The master may be made from any suitable material and may be of any suitable shape. An example of a master might be a silicon wafer. The polymeric material is then cured and separated, e.g. peeled away from the master mould and cut into appropriately sized stamps which may be of any suitable shape but which are generally, circular, rectangular or square shaped. Preferably, the region of each stamp that has been in contact with the master mould is cleaned, for example using either a dilute solution of an organopolysiloxane in a low-boiling solvent, or the low boiling solvent alone and then allowed to dry. Any suitable low-boiling solvent may be utilised e.g. alkanes such as pentane and hexane or tetrahydrofuran.

A layer of the organopolysiloxane used in accordance with the process of the present invention is then applied on to a stamp either neat or in the form of a dilute solution in a low-boiling solvent as hereinbefore described. The coated surface of the stamp is then brought into contact with the substrate surface and the stamp is the subsequently removed leaving a printed pattern on the substrate surface. The inventors have also identified that subsequent to the printing step the substrate on which a pattern of organopolysiloxane is printed may be further modified by any suitable method dependent on the form of organopolysiloxane used.

Furthermore, different regions of the substrate may be provided with different surface properties by means of masking areas of the substrate at different points in time of the treatment process. Regions of the substrate may be masked, i.e. causing a particular treatment step not to take place in a certain region. This might involve masking the substrate from plasma treatment or subsequent printing of liquid organopolysiloxane polymer/oligomer and/or polysilane or preventing post -treatment of a region after a patterned thin layer has been printed on to the substrate surface. An example of masking might be masking the surface of part of a micro contact printed region of substrate during subsequent oxygen plasma treatment such that part of the printed surface is oxidised and part remains the same as before plasma treatment thereby causing different regions to have different chemical or physical properties, in this case differing degrees of hydrophilicity would be achieved. In other examples, the surface might be part oxidised and available for chemical bonding/reaction and part unreactive to further coatings. Masking may also take place by way of printing a thin film down onto a substrate before a further step takes place.

The liquid coating material or ink used in the soft lithographic printing process is selected from organopolysiloxane polymers, organopolysiloxane oligomers, siloxane resins and polysilanes. The liquid organopolysiloxane polymer/oligomer used in the process of the present invention may be any appropriate linear, branched or cyclic organopolysiloxane or copolymers thereof such as for example silicone polyethers. For the sake of the present invention, the liquid coating material or ink shall also include low molecular weight silicone resins in liquid or wax form if, in the latter case, said wax is readily dissolvable in a suitable low-boiling solvent.

Linear or branched organopolysiloxane polymer/oligomers which are suitable as liquid precursors for use in the method in accordance with the present invention include liquids of the general formula W-A-W where A is a polydiorganosiloxane chain having siloxane units of the formula R″ₛSiO_{4-s/2} in which each R″ independently represents an alkyl group having from 1 to 40 carbon atoms, an alkenyl group such as vinyl, propenyl and/or hexenyl groups; hydrogen; an aryl group such as phenyl, a halide group, an alkoxy group, an epoxy group, an acryloxy group, an alkylacryloxy group, wherein any of the R″ groups may contain fluorine groups. Generally, s has a value of 2 but in branched organopolysiloxanes and/or silicone resins s will at least partially be 0 or 1. Preferred materials have polydiorganosiloxane chains according to the general formula —(R″₂SiO)ₘ— in which each R″ is independently as hereinbefore described and m has a value from about 1 to about 4000. Suitable materials have viscosities in the order of about 0.5 mm²S⁻¹ to about 1,000,000 mm²S⁻¹. When high viscosity materials are used, they may be diluted in suitable low-boiling, solvents, such as for example tetrahydrofuran or alkanes such as pentane and hexane to enable a suitable method of application.

The groups W may be the same or different. The W groups may be selected, for example, from —Si(R″)₂X, or
—Si(R″)₂—(B)_{d}—R″′SiR″ₖ(X)₃₋ₖ
where B is —R″′—(Si(R″)₂—O)ᵣ—Si(R″)₂— and R″ is as aforesaid, R″′ is a divalent hydrocarbon group r is zero a whole number between 1 and 6 and d is 0 or a whole number, most preferably d is 0, 1 or 2, X may be the same as R″ or a hydrolysable group such as an alkoxy group containing alkyl groups having up to 6 carbon atoms, an epoxy group or a methacryloxy group or a halide. Preferably, the organopolysiloxane is not a chlorine terminated polydimethylsiloxane having a degree of polymerisation of between 5 and 20 and wherein each terminal silicon contains between 1 and 3 Si—Cl bonds.

Cyclic organopolysiloxanes having the general formula (R″₂SiO _{2/2})ₙ wherein R″ is hereinbefore described, n is from 3 to 100 but is preferably from 3 to 22, most preferably n is from 3 to 6. Liquid precursors may comprise mixtures of cyclic organopolysiloxanes as hereinbefore defined.

The linear or branched organopolysiloxane polymer/oligomers for use in the present invention may also comprise mixtures comprising one or more of the linear or branched organopolysiloxanes as hereinbefore described with one or more of the cyclic organopolysiloxanes as hereinbefore described. One preferred organopolysiloxane polymer/oligomer is trimethylsilyl end-blocked polydimethylsiloxane (hereafter referred to as PDMS). Any suitable polysilane comprising units of the formula R″ₛSi_{4-s/2} wherein R″ and s are as previously defined may be utilised but polysilanes with a degree of polymerisation of at least 10 are preferred.

Silicone resins are generally described using the M, D, T and Q nomenclature in which M units have the general formula R₃SiO_{1/2}, D units have the general formula R₂SiO_{2/2}, T units have the general formula RSiO_{3/2} and Q units have the general formula SiO_{4/2}. Generally, unless otherwise indicated, each R group is normally an organic hydrocarbon group, such as an alkyl group (e.g. methyl or ethyl) or an alkenyl group e.g. vinyl or hexenyl), however some of the R groups may be silanol groups). Any suitable polysiloxane resin comprising Q and/or T groups in addition to M and optionally D groups may be utilised as inks in the present invention.

Chemical modification of the resulting coated surface may be carried out in cases where the organopolysiloxane coating contains reactive groups, which are available for bonding and/or reacting with other molecules. A particular example would be to provide a thin film on the substrate with organopolysiloxane polymer/oligomer containing multiple Si—H H bonds to which in certain regions of the printed layer a catalyst for electroless metalisation is subsequently deposited. Alternatively an additional coating step may be utilised over the same or a different region of the substrate to effect a (region specific) change in the chemical properties of the substrate surface. In a still further alternative, the resulting coated substrate may be plasma treated, for example, in the presence of an oxidising or reducing gas in order to chemically modify the coated layer or a non-coated region of the substrate. In the case of using an oxidising plasma, coated surface areas may become hydrophilic and very slowly return to being hydrophobic (recover). Films may also be recoated to give some areas of the substrate that are hydrophilic and others that are hydrophobic. The present invention is also suited to other forms of printing such as for example ink jet and flexographic printing techniques.

Where appropriate, the substrates may be pre-treated, i.e. for example a layer of a compound may be deposited on the substrate prior to the process of the present invention or after plasma treatment of the substrate surface but prior to the application of the preformed mould onto the substrate surface. Any suitable method may be used for applying such a layer examples include spin-coating and dip-coating but one particularly preferred method is described in PCT patent application WO 02/28548 and PCT patent application WO 03/086031 (published after the priority date of the present application) the contents of which are included herein by reference. This preferred pre-treatment process involves introducing an atomised liquid and/or solid coating-forming material into an atmospheric pressure plasma discharge and/or an ionised gas stream resulting therefrom, and exposing the substrate to the atomised coating-forming material under conditions of atmospheric pressure.

Under oxidising conditions, the pre-treatment method may be used to form an oxygen containing coating on the substrate. For example, silica-based coatings can be formed on the substrate surface from atomised silicon-containing coating-forming materials. Under reducing conditions, the present method may be used to form oxygen free coatings, for example, silicon carbide based coatings may be formed from atomised silicon containing coating forming materials.

The type of coating which is formed on the substrate during the pre-treatment step is determined by the coating-forming material(s) used, and the present method may be used to (co) polymerise coating-forming monomer material(s) onto the substrate surface. The coating-forming material may be organic or inorganic, solid, liquid or gaseous, or mixtures thereof. Suitable organic coating-forming materials include carboxylates, methacrylates, acrylates, styrenes, methacrylonitriles, alkenes and dienes, for example methyl methacrylate, ethyl methacrylate, propyl methacrylate, butyl methacrylate, and other alkyl methacrylates, and the corresponding acrylates, including organofunctional methacrylates and acrylates, including glycidyl methacrylate, trimethoxysilyl propyl methacrylate, allyl methacrylate, hydroxyethyl methacrylate, hydroxypropyl methacrylate, dialkylaminoalkyl methacrylates, and fluoroalkyl (meth)acrylates, methacrylic acid, acrylic acid fumaric acid and esters, itaconic acid (and esters), maleic anhydride, styrene, α-methylstyrene, halogenated alkenes, for example, vinyl halides, such as vinyl chlorides and vinyl fluorides, and fluorinated alkenes, for example perfluoroalkenes, acrylonitrile, methacrylonitrile, ethylene, propylene, allyl amine, vinylidene halides, butadienes, acrylamide, such as N-isopropylacrylamide, methacrylamide, epoxy compounds, for example glycidoxypropyltrimethoxysilane, glycidol, styrene oxide, butadiene monoxide, ethyleneglycol diglycidylether, glycidyl methacrylate, bisphenol A diglycidylether (and its oligomers), vinylcyclohexene oxide, conducting polymers such as pyrrole and thiophene and their derivatives, and phosphorus-containing compounds, for example dimethylallylphosphonate.

Inorganic coating-forming materials suitable for the optional pre-treatment step include metals and metal oxides, including colloidal metals. Organometallic compounds may also be suitable coating-forming materials, including metal alkoxides such as titanates, tin alkoxides, zirconates and alkoxides of germanium and erbium.

Substrates may alternatively be coated with silica- or siloxane-based coatings during the optional pre-treatment step by application of coating-forming compositions comprising silicon-containing materials onto the substrate. Suitable silicon-containing materials which may be applied in the pre-treatment step include silanes (for example, silane, alkylsilanes alkylhalosilanes, alkoxysilanes) and linear (for example, polydimethylsiloxane) and cyclic siloxanes (for example, octamethylcyclotetrasiloxane), including organo-functional linear, cyclic siloxanes (for example, Si—H containing, halo-functional, and haloalkyl-functional linear and cyclic siloxanes, e.g. tetramethylcyclotetrasiloxane and tri(nonofluorobutyl) trimethylcyclotrisiloxane) and silicone resins. A mixture of different silicon-containing materials may be used, for example to tailor the physical properties of the substrate coating for a specified need (e.g. thermal properties, optical properties, such as refractive index, and viscoelastic properties).

It is found by the inventors that the printed coatings of the present invention are seemingly significantly better than those discussed in the teachings of Xia et al ibid and require no physical “ripping” of the stamp away to leave cured PDMS in place as is required in the DTM process described in the prior art. A Simple pre-coating exposure to plasma results in a substrate surface able to interact with applied organopolysiloxanes without the need of a curing step as required in the prior art. As indicated previously these findings are contrary to the teachings in Xia et al ibid.

One advantage of such coatings is that they are optically transparent. Alternatively or after any chemical modification, the printed substrates may be subjected to an etching process wherein the printed layer acts as a guide for the etching process. The printed layer may also be used as a catalyst or reaction initiator when suitable groups are sterically unhindered or may be available for reaction with other compounds or as an inhibitor of other reactions.

One application of the soft lithographic printing process described in the present invention is in relation to its use for the modification of molecular alignment, particularly liquid crystal alignment and the alignment of liquid crystal guest-host systems (i.e. liquid crystals having functional additives that reorieintate with the liquid crystal) including dyes and selected chromophores. This may be exemplified by depositing patterned siloxane layers onto glass slides and then placing liquid crystals thereon. The alignment of the liquid crystal film is modified over regions where siloxane has been deposited compared to alignment over regions without siloxane. A wide range of siloxane based inks have been found to be effective. The modifications in alignment are found to be stable to heating, rubbing and moderate shearing, unlike for systems on glass substrates which are not plasma pre-treated but are μ contact printed with a PDMS pattern where the effect was not durable on temperature cycling. Clear definition of features down to sizes of 1 μm have been obtained but it is believed that this is not limiting being related to available masters rather than the system. Whilst many methods for modifying Liquid Crystal alignment are known (e.g. the use of silane monolayers) this is believed to be the first example of such modification utilising siloxanes or Liquid crystal functionalised siloxanes.

Other uses include, for example, the printing of hydrophobic tracks to control material placement during subsequent processes such as spin-coating and ink-jet printing.

The present invention will now be described further based on the following examples and drawings in which:

FIG. 1 is a figurative explanation of the making of a stamp and use thereof in μ contact printing (μCP).

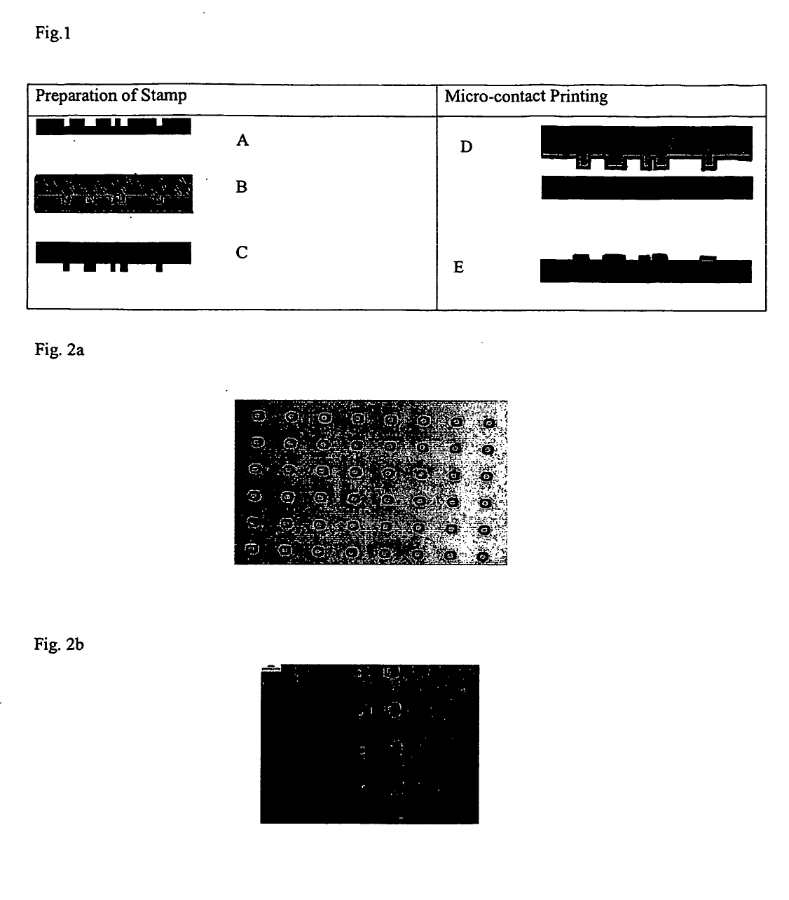

FIGS. 2a and 2b are photographs of simple μCP stamps

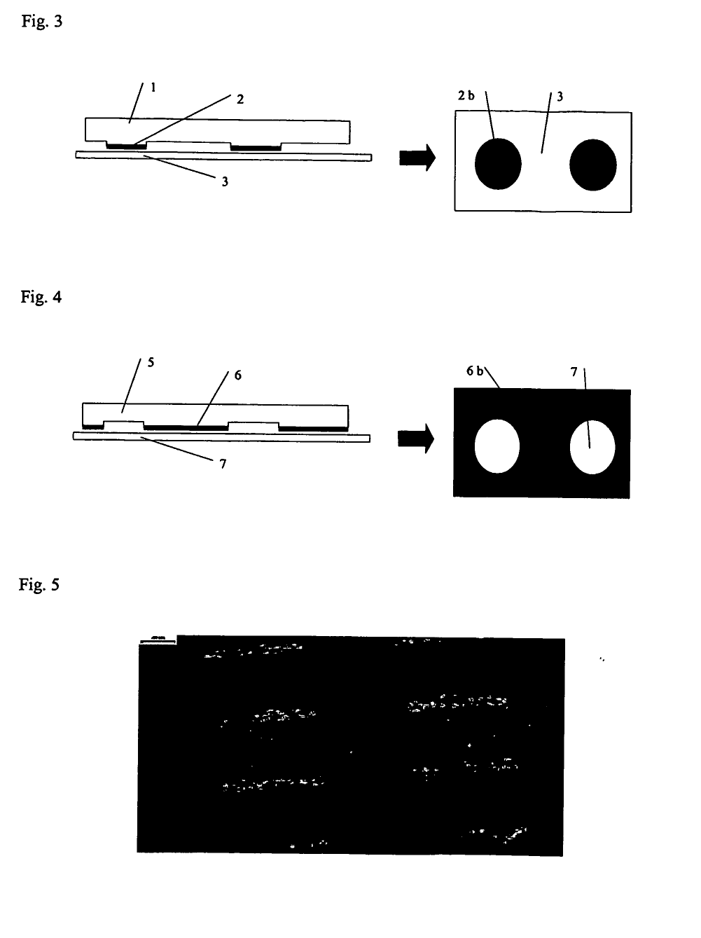

FIG. 3 is an indication of the Printing of a Positive Pattern by μCP techniques

FIG. 4 is an indication of the Printing of a Negative Pattern by μCP techniques

FIG. 5 is an E7 liquid crystal alignment on negative pattern of C₃₀-PDMS₃₀-C₃₀ printed on glass

A as indicated in FIG. 1 is intended to depict a master mould from which suitable moulds or stamps for soft lithographic printing in accordance with the present invention may be fabricated. Printing moulds or Stamps for use in the method of the present invention were prepared by standard soft lithographic techniques. The master mould may, for example, be a patterned and/or etched silicon wafer into which is poured a curable liquid silicone rubber. A suitable polymer for this purpose is SYLGARD® 184 Silicone Elastomer which may be cast by pouring into the master mould and curing the mould/stamp as indicated by step B of FIG. 1. The resulting mould/stamp as seen in section C of FIG. 1 is then peeled from the master mould and is ready for the addition of “ink” into/onto the mould. The ink is applied by coating contoured side of the stamp with an appropriate ink. Any suitable ink in accordance with the invention may be utilised such as an organopolysiloxane alone or in a solution diluted in suitable low-boiling solvents, such as for example tetrahydrofuran or alkanes such as pentane and hexane, dependent on the initial viscosity of the organopolysiloxane but preferably in accordance with this invention the solvent where required is pentane. Micro contact printing is achieved in accordance with the present invention by applying liquid ‘ink’ onto the mould/stamp and then placing the inked side of the mould/stamp onto a previously prepared (plasma treated) substrate (D in FIG. 1) with an appropriate degree of pressure applied. After a preset time the mould/stamp is removed and a patterned thin film is left on the surface of the substrate (E).

FIGS. 2a and 2b are photographs of pillared moulds suitable for use in micro contact printing. FIG. 2a shows a mould having 20 μm projections or post out of the bulk stamp. Such a mould is prepared by following the process seen in FIG. 1 wherein the master mould has 20 μm holes into which the liquid mould material is poured and from which the 20 μm posts are replicated for use as the mould. FIG. 2b is an angled view of a mould/stamp having 30 μm posts in the same manner described.

FIG. 3 depicts the micro contact printing of a positive pattern onto a substrate subsequent to plasma treatment of the substrate in accordance with the present invention. In FIG. 3 the mould/stamp 1 has had ink applied to the posts 2 and is being applied onto substrate 3. After a predetermined time the mould/stamp is removed resulting in two printed circles 2b surrounded by a bulk unprinted region on the substrate. Minimal reactive spreading of the ink into the unprinted region was usually noted by the inventors.

FIG. 4 depicts the micro contact printing of a negative pattern onto a substrate subsequent to plasma treatment of the substrate in accordance with the present invention. In FIG. 4 the mould/stamp 5 is provided with holes and has ink applied to the regions 6 thereof surrounding said holes, with the holes remaining un-inked. The inked mould/stamp 5 is being applied onto substrate 3 and then after a predetermined time the mould/stamp 5 is removed resulting in two unprinted circles 7 surrounded by a bulk printed region 6b on the substrate. Minimal reactive spreading of the ink into the unprinted region was usually noted by the inventors.

Where provided in the following examples, it is to be understood that all Contact angle measurements were, unless otherwise indicated, undertaken using an AST VCA2000 Video Contact Angle System and were repeated at least 3 times in different areas of the sample and results averaged.

### EXAMPLE 1

### Soft Lithographic Stamping Using a Micro Contact Printing (μCP) Technique

Planar (flat) Stamps for use in this process were prepared by standard soft lithographic techniques as described in relation to FIG. 1 above. In the present series of examples the stamps were made as follows:

SYLGARD® 184 Silicone Elastomer parts A and B were mixed in a 10:1 ratio, de-aerated under vacuum and poured onto a flat silicon wafer in a petri dish. The SYLGARD® 184 Silicone Elastomer was cured at 65° C. for 2 hours, peeled from the silicon wafer and cut into 1×2 cm rectangles. The side that had been in contact with the silicon was wiped with a dilute solution of siloxane in pentane and allowed to dry.

The substrate (Glass microscope slide, plastic film, silicon wafer etc) was plasma treated using a Harrick PDC-002 Plasma cleaner (Harrick Scientific Corp., Ossining, N.Y., USA.) operating at a radio frequency between 10 and 12 MHz. The chamber volume was 3000 cm³. Initially, the plasma apparatus was pumped down to a base pressure of 0.008 mbar (0.8 Pa). The process gas was introduced into the chamber to a pressure of 0.2 mbar (20 Pa) for two minutes, and the plasma activated for 10 minutes at this pressure at high power to thoroughly clean the chamber. The plasma was then deactivated, and the chamber flushed with process gas for a further two minutes. The chamber was then vented, the sample was inserted, and the chamber was pumped down to 0.008 mbar (0.8 Pa). Process gas was then introduced at a pressure of 0.2 mbar (20 Pa), and the plasma activated for 60 seconds using the low power setting of 7.2 W. The chamber was then vented to air and the samples were removed and analysed. All PDMS coated substrates were washed with toluene (three times) and put in an oven at 140° C. for 30 minutes to remove any residual adsorbed toluene. They were allowed to cool and the contact angle of water was measured.

Immediately (<5 minutes) after plasma treatment the siloxane coated side of the SYLGARD® 184 Silicone Elastomer stamp prepared as described above was brought into contact with the substrate and mild pressure applied by hand to ensure good contact, the stamp was removed after about 30 seconds. The sample was allowed to stand for about 30 minutes and was then washed in toluene 3 times and dried before contact angle measurements taken. At this point, no siloxane film could be visually detected on the slide, however on breathing on the slide the printed pattern was clear!y exposed due to differential hydrophobicity between the printed and unprinted regions.

SiOx coated PET was prepared using the process described in WO 02/28548 and the equipment described in and PCT patent application no PCT/EP03/04349. The PET substrate was coated by means of atmospheric pressure glow discharge (APGD) apparatus. A plasma region was formed between two adjacent electrodes encased in a dielectric. The distance of the gap between the glass dielectric plates attached to the two electrodes was 6 mm and the surface area of each electrode was (10 cm×60 cm). The process gas used was helium or a mixture of helium and oxygen. The plasma power to both zones 0.4 kW, voltage was 4 kV and the frequency was 29 kHz. The operating temperature was below 40° C.

The substrate was passed through both the plasma zone using a reel to reel mechanism utilising a guide means to assist in the transport of the substrate both into and out of-the plasma zone. The speed of the substrate passing through the plasma zone was 4 m min⁻¹. The substrate was transported through the plasma region of the system on three occasions. During the first pass through the plasma region the plasma gas consisted of helium at a flow rate of 19.5 Standard Litres per minute (SLM) and oxygen at a flow rate of 0.075 SLM. Liquid PDMS (5 mm 2S⁻¹) was introduced into the system through a Sonotec ultrasonic nozzle into the plasma/coating zone at a rate of 12.5 μl min⁻¹ resulting in an application of an SiOx coating on the PET passing through the plasma region. The second pass of the PET through the plasma zone was the same as the first pass other than the fact that no liquid PDMS was introduced into the plasma zone used. The third and final pass of the substrate through the plasma zone was identical to the first pass and a further coating of SiOx was applied onto the PET substrate surface. In the case of the present invention no further plasma treatment of the surface of the substrate was deemed necessary and the coating was applied in accordance with the present invention.

Contact angle of water was measured using an AST VCA2000 Video Contact Angle System. Contact angles were measured at least 3 times on both printed and unprinted regions and results for each region averaged. Results are given in Table 1.

TABLE 1
Contact Angle Results - Printed vs. Unprinted Regions

| | | Average |
|---|---|---|
| | Average | Contact |
| | Contact Angle - | Angle - |
| | Printed Region | Unprinted |
| Substrate/Fluid | (°) | Region (°) |
| Glass/PDMS (350 mm²S⁻¹) | 104.5 | 23.7 |
| As above after storing in | 105.8 | 34.2 |
| petri dish in air for 4 weeks | | |
| Glass/PDMS (350 mm²S⁻¹) | 102.9 | 17.9 |
| (Repeat Experiment) | | |
| As above after soaking in | 101.8 | 33.9 |
| toluene overnight | | |
| As above after toluene soak | 101.5 | 38.7 |
| and storing in petri dish in | | |
| air for 4 weeks | | |
| Glass/Trimethyl silyl end- | 98.5 | 11.0 |
| blocked methylhydrogen | | |
| siloxane | | |
| As above after storing in | 101.1 | 28.3 |
| petri dish in air for 1 day | | |
| Glass/Trimethyl silyl end- | 84.4 | 13.2 |
| blocked phenyl silsesquioxane | | |
| As above after storing in | 88.9 | 9.9 |
| petri dish in air for 1 day | | |
| Glass/C₃₀ end blocked PDMS | 81.5 | 67.6 |
| (30 dp) | | |
| As above after storing in | 80.4 | 72.9 |
| petri dish in air for 4 weeks | | |
| Glass/Poly(hexadecyl- | 52.2 | 46.7 |
| methylsiloxane) | | |
| As above after storing in | 59.9 | 60.3 |
| petri dish in air for 4 weeks | | |
| Glass/silicone Polyether | 55.8 | 43.9 |
| As above after storing in | 56.3 | 56.4 |
| petri dish in air for 10 days | | |
| Glass/Poly(perfluoro- | 117.0 | 73.8 |
| octylhexylmethyl, dimethylsiloxane) | | |
| Silicon/PDMS (350 mm²S⁻¹) | 105.0 | 24.6 |
| As above after soaking in | 99.8 | 41.2 |
| toluene overnight | | |
| As above after toluene soak | 101.9 | 52.6 |
| and storing in petri dish in | | |
| air for 4 weeks | | |
| Silicon/Trimethyl silyl end- | 95.5 | 31.1 |
| blocked methylhydrogen | | |
| siloxane | | |
| As above after storing in | 100.6 | 50.4 |
| petri dish in air for 4 weeks | | |
| PET/PDMS (350 mm²S⁻¹) | 75.3 | 53.2 |
| As above after toluene soak | 89.6 | 62.3 |
| and storing in petri dish in | | |
| air for 4 weeks | | |
| SiOx coated PET/not further | 73.9 | 62.8 |
| plasma treated/PDMS (350 | | |
| mm²S⁻¹) | | |
| As above after soaking in | 73.9 | 61.2 |
| toluene overnight | | |
| SYLGARD ® 184 Silicone | 87.7 | 98.7 |
| Elastomer sheet/silicone | | |
| polyether | | |
| As above after storing in | 99.8 | 103.9 |
| petri dish in air for 10 days | | |
| Phenyl Siloxane Resin/PDMS | 94.4 | 36.4 |
| (350 mm²S⁻¹) | | |
| As above after storing in | 100.6 | 51.7 |
| petri dish in air for 14 days | | |
| Phenyl Siloxane Resin/ | 93.7 | 38.3 |
| Trimethyl silyl end-blocked | | |
| methylhydrogen siloxane | | |
| As above after storing in | 91.3 | 59.4 |
| petri dish in air for 14 days | | |

The results in Table 1 show clear differentiation for siloxanes printed onto a range of substrates including glass and silicon. The contact angle observed for the siloxane printed regions remained reasonably consistent with washing or time showing good anchorage of the siloxane to the substrate.

### EXAMPLE 2

This example was designed to show the versatility of the process in accordance with the present invention by micro-contact printing onto a variety of different substrate materials, namely an Au/Pd sputtered glass microslide, a carbon coated glass slide, copper foil and aluminium foil.

The Au/Pd substrate was prepared by coating a glass microscope slide with Au/Pd using a Hammer X Sputter Coater. The sample was placed in the machine and the pressure reduced to <0.04 Torr (5.332 Nm⁻²) before introducing argon gas to a pressure of approximately 0.06 Torr (7.998Nm ⁻²). The Au/Pd was then sputtered onto the surface of the glass slide using a high voltage of 2400 V at 10 mA for 120 secs.

The carbon substrate was prepared by coating a glass microscope slide with carbon using an Emitech K950 Carbon Evaporator Coater Unit by passing current through a carbon rod under vacuum allowing the carbon to be deposited onto the surface.

The results in Table 2a provide details of contact angles measured on starting material substrates prior to plasma treatment. This was undertaken to establish the effect of toluene washing on the surface properties. It was noted that in the case of the two deposited coatings, Au/Pd and C, the washing did affect the contact angles measurements significantly.

TABLE 2a
Contact Angle Results - Other Substrates:
Starting Materials before Treatment

| | |
|---|---|
| Contact Angle - | Contact Angle - |
| Starting Material (°) | Washed Toluene (°) |

| Substrate | Average | S.D. | Average | S.D. |
|---|---|---|---|---|
| Au/Pd | 45.7 | 1.7 | 64.2 | 1.3 |
| C | 63.8 | 0.8 | 76.8 | 1.4 |
| Cu Foil | 114.2 | 0.6 | 111.8 | 2.1 |
| Al | 102.3 | 1.8 | 98.1 | 0.9 |

The substrates were plasma treated as described in Example 1 and then printed with PDMS (350 mm²S⁻¹). After washing with toluene the contact angles were measured and the results are provided in Table 2b. Whilst it is to be appreciated that the printed regions using PDMS (350 mm²S⁻¹) in these examples gave lower contact angles than printed regions on glass substrates (>100°) there was a clear differentiation noted both between the properties of the starting substrate and the printed region of the post treated substrate and between the printed and unprinted region on the plasma treated examples.

TABLE 2b
Contact Angle Results - Printed vs.
Unprinted Regions - Other Substrates

| | |
|---|---|
| Contact Angle - | Contact Angle - |
| Printed Region (°) | Unprinted Region (°) |

| Substrate | Average | S.D. | Average | S.D. |
|---|---|---|---|---|
| Au/Pd | 97.6 | 2.2 | 73.7 | 1.6 |
| C | 71.3 | 0.9 | 41.7 | 19.6 |
| Cu Foil | 89.4 | 7.6 | 74.1 | 4.8 |
| Al | 71.9 | 6.6 | 26.1 | 2.8 |

### EXAMPLE 3

sIn this example the substrate used was an Indium Tin Oxide (ITO) coated plastic. The substrate was treated using PDMS (350 mm 2S⁻¹) and the method described in example 1. The results in Table 3 clearly differentiate between the printed and unprinted regions. Differentiation between the printed and unprinted regions for the micro-contact printing of Trimethyl silyl end-blocked methyl hydrogen siloxane was also observed.

TABLE 3
Contact Angle Results -Printed vs.
Unprinted Regions - ITO on plastic

| | Contact Angle - | | Contact Angle - | |
|---|---|---|---|---|
| | Printed Region (°) | | Unprinted Region (°) | |
| Fluid | Average | S.D. | Average | S.D. |
| 350 mm²S⁻¹ | 100.2 | 4.2 | 57.2 | 5.2 |
| PDMS | | | | |
| Trimethyl silyl | 93.1 | 10.3 | 72.8 | 14.1 |
| end-blocked | | | | |
| methylhydrogen | | | | |
| siloxane | | | | |

It is clear therefore, that micro contact printing can be used to deposit liquids as hereinbefore defined onto selected areas of a range of plasma treated substrates as exemplified by PDMS, and methylhydrogensiloxane giving consistent transfer and contact angles in the region of 100° and greater, allowing good differentiation between printed and non-printed regions.

### EXAMPLE 4

### Higher Viscosity Fluids

High viscosity PDMS was printed onto glass slides using the same process as described in example 1 wherein samples of PDMS having viscosities of 12,500, 30 000 and 60 000 mm²S⁻¹ were inked onto a standard SYLGARD® 184 flat stamp and then was printed onto a glass substrate results compared after printing onto a glass substrate. The results to be found in Table 4a indicate that printing films using high viscosity PDMS liquids also gave very positive results for glass substrates.

TABLE 4a
Contact Angle Results - Printed vs. Unprinted Regions -
Higher Viscosity PDMS Fluids on Glass

| | | |
|---|---|---|
| PDMS | Contact Angle - | Contact Angle - |
| Viscosity | Printed Region (°) | Unprinted Region (°) |

| mm²S⁻¹ | Average | S.D. | Average | S.D. |
|---|---|---|---|---|
| 12 500 | 97.6 | 4.2 | 26.1 | 4.0 |
| 30 000 | 101.3 | 2.6 | 24.6 | 7.3 |
| 60 000 | 93.6 | 2.0 | 29.9 | 4.0 |

In order to show that the preparatory treatment of the ink had little effect on the printed end result the liquids used were applied onto a stamp and treated in three different ways prior to application onto glass substrates. These were:
i) ink on stamp for 15 mins prior to application on plasma treated slide;
ii) ink on stamp for 1 hr prior to application on plasma treated slide; and

iii) stamping three times on plain glass before stamping on the desired plasma treated glass. The results are given in Table 4b and show in all cases the PDMS has been successfully transferred onto the glass substrate.

TABLE 4b
Contact Angle Results- Different Print Conditions

| | 1) Ink Time on | | 2) Ink Time on | | | |
|---|---|---|---|---|---|---|
| | Stamp (15 mins) | | Stamp (1 hr) | | 3) Pre-printed ×3 | |
| PDMS | Contact Angle ° Average | | | | | |
| Viscosity | Un- | | Un- | | Un- | |
| mm²S⁻¹ | printed | Printed | printed | Printed | printed | Printed |
| 30,000 | 56.1 | 107.4 | 63.2 | 107.7 | 46.8 | 105.1 |
| 60,000 | 61.9 | 107.1 | 63.6 | 106.9 | 47.2 | 105.4 |
| 150,000 | 63.8 | 106.1 | 66.1 | 106.5 | 38.8 | 101.4 |

### EXAMPLE 5

### Plasma Retreatment and Printing of Siloxane Thin Films

Glass slides were initially plasma treated (Harrick PDC-002 Plasma cleaner, low power) in oxygen gas (pressure 0.2 mbar (20 Pa), 60 s treatment). Immediately (<5 minutes) after plasma treatment, silicone was poured onto the substrate to completely cover it, and then left to stand overnight. The sample was washed in toluene 3 times and dried before contact angle measurement. In some cases, the sample was immersed in toluene overnight and rewashed with toluene to ensure complete removal of unreacted siloxane.

Contact angle of water was then measured (AST VCA2000 Video Contact Angle System) at least 3 times and results (which are indicated in the “Original” column in Table 5) were averaged.

The glass microscope slides coated with the silicone were plasma treated (Harrick PDC-002 Plasma cleaner, low power) in oxygen gas (pressure 0.2 mbar (20 Pa), 60 s treatment). Immediately (<5 minutes) after plasma treatment a section of the film was re-printed with PDMS (350 mm²S⁻¹), using a plain flat Sylgard stamp. The contact angle of water was then measured periodically over 3 months (AST VCA2000 Video Contact Angle System) at least 3 times on both unprinted (Table 5a) and printed (Table 5b) regions and the results for each region were averaged.

In this example a selection of the thin films of different siloxanes on glass slides as previously discussed in Example 3 were further plasma treated using the Harrick PDC-002 Plasma cleaner and the process described in example 1 to investigate the durability of subsequent plasma treatments on the thin film itself.

The results given in Table 5a show the contact angle measurements (°) on the plasma re-treated but unprinted films over a period of 3 months. It is to be noted that the plasma treatment results in substantially more hydrophilic surfaces on the glass substrates which hydrophilic nature is only gradually lost over the three month period of testing.

TABLE 5a

| | | PLASMA TREATED | | | | |
|---|---|---|---|---|---|---|
| | ORIGINAL | RECOVERY TIME (days) | | | | |
| FLUID | (°) | 2 | 16 | 30 | 45 | 92 |
| PDMS (20 mm²S⁻¹) | 98.0 | 56.9 | 61.3 | 61.8 | 71.7 | 81.0 |
| PDMS (12500 mm²S⁻¹) | 88.4 | 50.2 | 55.4 | 61.9 | 66.2 | 75.1 |
| Trimethyl silyl end-blocked | 77.2 | 58.4 | 70.4 | 72.5 | 68.6 | 76.2 |
| phenyl silsesquioxane | | | | | | |
| Decamethylcyclopentasiloxane | 91.9 | 52.5 | 58.6 | 58.8 | 70.0 | 76.2 |
| Hydroxydimethyl silyl end- | 98.1 | 40.4 | 39.4 | 31.4 | 45.1 | 52.0 |
| blocked polydimethylsiloxane | | | | | | |
| (˜40 dp) | | | | | | |
| Trimethyl silyl end-blocked | 84.0 | 51.9 | 47.2 | 53.5 | 57.7 | 63.0 |
| dimethyl, methylphenyl siloxane | | | | | | |
| DiMethylHydrogen Silyl end- | 97.1 | 40.2 | 47.2 | 55.8 | 57.0 | 66.2 |
| blocked dimethyl siloxane | | | | | | |
| (50 dp) | | | | | | |
| PDMS (350 mm²S⁻¹) | 100.2 | 53.6 | 41.1 | 75.6 | 60.7 | 84.0 |
| (Glass 20 s plasma treatment) | | | | | | |
| PDMS (350 mm²S⁻¹) | 102.4 | 54.5 | 53.7 | 59.8 | 62.0 | 67.9 |
| (glass 60 s plasma treatment) | | | | | | |
| Trimethyl silyl end-blocked | 101.5 | 57.1 | 60.0 | 64.0 | 54.7 | 74.2 |
| methylhydrogen siloxane | | | | | | |
| Trimethyl silyl end-blocked | 103.5 | 57.8 | 78.7 | 80.1 | 93.7 | 97.2 |
| dimethyl, methylhydrogen | | | | | | |
| siloxane | | | | | | |
| Silicone polyether | 35.1 | 59.9 | 57.9 | 60.9 | 62.6 | 63.1 |

A section of the re-plasma treated, previously coated substrates detailed in Table 5a were additionally printed using a μCP stamp with a PDMS (350 mm²S⁻¹) ink, using the stamping technique described in example 1. The contact angles (°) of the plasma retreated and printed region were measured periodically over the 3 months and results are provided in Table 5b. These results show that in the majority of the samples the μCP printed region exhibits contact angles around the expected 100° and these do not significantly change over time.

TABLE 5b

| | | PLASMA TREATED AND PRINTED | | | | |
|---|---|---|---|---|---|---|
| | ORIGINAL | RECOVERY TIME (days) | | | | |
| FLUID | (°) | 2 | 16 | 30 | 45 | 92 |
| PDMS (20 mm²S⁻¹) | 98.0 | 94.2 | 83.3 | 101.4 | 105.1 | 102.4 |
| PDMS (12500 mm²S⁻¹) | 88.4 | 96.8 | 102.3 | 99.6 | 98.9 | 98.4 |
| Trimethyl silyl end-blocked | 77.2 | 97.0 | 97.6 | 98.8 | 94.7 | 99.9 |
| phenyl silsesquioxane | | | | | | |
| Decamethylcyclopentasiloxane | 91.9 | 96.9 | 95.8 | 92.8 | 96.9 | 98.8 |
| Hydroxydimethyl silyl end- | 98.1 | 95.9 | 100.0 | 99.9 | 98.5 | 101.5 |
| blocked polydimethylsiloxane | | | | | | |
| (˜40 dp) | | | | | | |
| Trimethyl silyl end-blocked | 84.0 | 87.4 | 101.4 | 99.8 | 95.6 | 94.2 |
| dimethyl, methylphenyl siloxane | | | | | | |
| DimethylHydrogen Silyl end- | 97.1 | 83.6 | 60.8 | 100.7 | 57.7 | 66.2 |
| blocked dimethyl siloxane | | | | | | |
| (50 dp) | | | | | | |
| PDMS (350 mm²S⁻¹) | 100.2 | 84.4 | 77.6 | 79.7 | 82.5 | 97.6 |
| (glass 20 s treatment) | | | | | | |
| PDMS (350 mm²S⁻¹) | 102.4 | 99.1 | 97.8 | 96.3 | 99.3 | 95.4 |
| (glass 60 s treatment) | | | | | | |
| Trimethyl silyl end-blocked | 101.5 | 103.9 | 106.8 | 106.4 | 103.7 | 104.9 |
| methylhydrogen siloxane | | | | | | |
| Trimethyl silyl end-blocked | 103.5 | 104.1 | 105.9 | 105.9 | 108.0 | 108.9 |
| dimethyl, methylhydrogen | | | | | | |
| siloxane | | | | | | |
| Silicone Polyether | 35.1 | 103.8 | 100.1 | 101.8 | 105.7 | 98.9 |

Table 5c is a comparative example which shows that the contact angle (°) for siloxane rubber blocks made from SYLGARD® 184 Silicone Elastomer return from a post plasma treated hydrophilic state to their original hydrophobic state in 3 to 4 days. The recovery time of a variety of

SYLGARD® 184 Silicone Elastomer samples after exposure to plasma, was carried out comparing washed/unwashed samples and extracted/non-extracted samples. Extracted samples had been left in ethanol and dried until the extractables/impurities had been removed. Washed samples were washed with toluene immediately after the plasma treatment, left to dry for about 10 mins and the contact angles were then measured. Water contact angles were measured for each sample before plasma treatment for comparison, and the samples were then oxygen plasma treated for 60 s on low power. Measurements for about 5 mins after plasma treatment were taken as soon as the samples were taken out of the plasma chamber. The samples left in air were put into a petri dish with no lid to leave exposed to air. As seen in Table 5c substrate surfaces change from a hydrophilic surface to an increasing hydrophobic surface over time. After plasma treatment the surface of blocks of SYLGARD® 184 Silicone Elastomer are seen to be wettable. but they recover in from 1 to 4 days to the original contact angles seen before plasma treatment. This finding is clearly in marked contrast to the plasma treated samples in Table 5a above wherein the samples had not returned to their original hydrophobic nature after a period of 3 months.

TABLE 5c

| | Before plasma | ˜5 | 15 | 30 | 45 | | | | | | | | |
|---|---|---|---|---|---|---|---|---|---|---|---|---|---|
| | treatment | mins | mins | mins | mins | 1 hr | 2 hrs | 4 hrs | 6 hrs | 19 hrs | 22 hrs | 28 hrs | 105 hrs |
| SYLGARD ® 184 Silicone | 107.9 | 17.8 | 40.3 | 48.4 | 51.9 | 54.9 | 63.5 | — | 85.5 | — | 97.6 | — | 105.2 |
| Elastomer | | | | | | | | | | | | | |
| SYLGARD ® 184 Silicone | 106.9 | — | 42.5 | 58.8 | — | 66.6 | 71.0 | — | — | 89.3 | — | — | 102.1 |
| Elastomer washed | | | | | | | | | | | | | |
| SYLGARD ® 184 Silicone | 108.9 | 28.8 | 52.7 | 53.7 | 59.8 | 61.7 | 88.5 | — | 99.9 | — | — | — | 106.3 |
| Elastomer extracted | | | | | | | | | | | | | |
| SYLGARD ® 184 Silicone | 109.7 | — | 29.0 | 45.8 | — | 61.2 | 64.3 | — | — | — | — | — | 101.7 |
| Elastomer washed & extracted | | | | | | | | | | | | | |
| SYLGARD ® 184 Silicone | 105.2 | — | 26.8 | 35.6 | 37.4 | 42.8 | 55.6 | 67.0 | — | — | 93.1 | 99.3 | — |
| Elastomer left in air | | | | | | | | | | | | | |

### EXAMPLE 6

### Siloxane Resin Substrates

Samples of a siloxane resin in the form of a cross-linked vinylated phenyl silsesquioxane resin were coated on glass slides, plasma treated in accordance with example 1 and subsequently micro-contact printed (in accordance with Example 1) in selected regions to investigate the durability of the plasma treatment and siloxane printing on a silicone resin. The results given in Table 6 show contact angle measurements for resin-coated slides that had been plasma treated and then micro-contact printed in specific areas with PDMS 350 mm²S⁻¹ and Trimethyl silyl end-blocked methylhydrogen siloxane. Contact angle measurements were taken over a period of 14 days after plasma treatment of the slides, measuring both the printed and unprinted regions of each slide.

TABLE 6
Micro-contact printing on Phenyl Resin Coated Slides after Plasma Treatment

| | Duration after plasma treatment | | | | | | | |
|---|---|---|---|---|---|---|---|---|
| | 1 hr | | 1 day | | 6 days | | 14 days | |
| | Contact Angle; | | Contact Angle; | | Contact Angle; | | Contact Angle; | |
| | Average | | Average | | Average | | Average | |
| Slides Printed | | Un- | | Un- | | Un- | | Un- |
| with | Printed | printed | Printed | printed | Printed | printed | Printed | printed |
| PDMS 350 | 94.4 | 36.4 | 100.5 | 48.9 | 97.4 | 55.7 | 100.6 | 51.7 |
| mm²S⁻¹ | | | | | | | | |
| Trimethyl silyl | 93.7 | 38.3 | 98.1 | 51.6 | 86.7 | 55.7 | 91.3 | 59.4 |
| end-blocked | | | | | | | | |
| methylhydrogen | | | | | | | | |
| siloxane | | | | | | | | |

Results showed good durability for the micro-contact printing of PDMS (350 mm²S⁻¹ ) and Trimethyl silyl end-blocked methylhydrogen siloxane giving high contact angles and a hydrophobic surface.

### EXAMPLE 7

### Liquid Crystal Alignment

Whilst many methods for modifying Liquid Crystal alignment are known including the use of silane monolayers this is believed to be the first example of such modification utilising PDMS via micro contact printing or like soft lithographic processes.

One application of the present invention is the provision of a wide variation of surface properties to modify liquid crystal alignment in specific areas and patterns. In a liquid crystal, it is well known, that the long-shaped molecules of the liquid can be given a common orientation or alignment. For example, in the case of “planar” alignment, the molecules are orientated parallel to the plane of a substrate. In the case of “homeotropic” alignment, they are disposed perpendicularly to said parallel planes. The result is that different optical properties are produced, which can be utilised in a variety of optical systems.

In a variation of the methods used above the SYLGARD® 184 Silicone Elastomer was poured onto silicon wafers that had been previously patterned by standard photolithographic techniques to give a range of round or square features (as can be seen in FIG. 2) with sizes between 5 and 250 μm and heights between 10 and 30 μm. Curing and pealing from the silicon wafer gave a SYLGARD® 184 Silicone Elastomer stamp that was patterned with a negative replica of the features on the wafer. This was then inked with dilute solutions of siloxanes in pentane, and allowed to dry. These stamps were designed such that printing with these will gave both positive (discrete features printed with siloxane) and negative (regions surrounding discrete features printed with siloxane) patterns as seen in FIGS. 3 and 4 respectively and were used to print pm scale featured PDMS films.

Substrates were plasma treated using the process described in Example 1. Immediately (<10 minutes) after plasma treatment, the inked SYLGARD® 184 Silicone Elastomer stamp was placed onto the substrate and allowed to remain in contact for up to several minutes. The stamp was then removed and any residue siloxane washed from the substrate with toluene and the substrate allowed to dry. At this point, no siloxane film could be visually detected on the slide, however on breathing on the slide the printed pattern was clearly exposed due to differential hydrophobicity between the printed and unprinted regions. A drop of liquid crystal was then placed on the patterned substrate and covered with a glass cover slip. Liquid crystal alignment was examined microscopically using crossed polars, samples were also heated into the isotropic phase, allowed to cool and re-examined.

Differential alignment in areas that were printed with PDMS was clearly observed and these were found to be durable to temperature cycling especially when compared with the combination of non-plasma treated glass and PDMS for which the effect was not durable on temperature cycling. It was found that regions that had been printed with siloxane gave homeotropic alignment of the liquid crystal.

This novel effect could be used to reduce switching voltages in LCDs, or be used to create novel, tuneable electro-optic devices in planar lightwave circuits. Results are given in Table 7

TABLE 7
Results for LC alignment on Siloxane patterned substrates

| Substrate/Siloxane/LC | Results |
|---|---|
| Glass/PDMS/E7 | Differential alignment |
| | seen for positive patterns |
| Glass/Trimethyl silyl end-blocked | Differential alignment |
| methylhydrogen siloxane/E7 | seen for positive patterns |
| Glass/Trimethyl silyl end-blocked | Differential alignment |
| phenyl silsesquioxane/E7 | observed for both positive |
| | and negative printed |
| | areas. Alignment retained |
| | after heating |
| Glass/Poly(hexadecyl)methysiloxane/ | Differential alignment |
| E7 | seen for positive patterns |
| | but not for negative patterns |
| Glass/C₃₀-PDMS₃₀-C₃₀/E7 | Differential alignment |
| | observed for both positive |
| | and negative printed areas. |
| PET/Trimethyl silyl end-blocked | No evidence for differential |
| methylhydrogen siloxane/E7 | alignment |
| PET/C₃₀-PDMS₃₀-C₃₀/E7 | Some differential alignment |
| | observed in small areas. |
| | Alignment retained after |
| | heating |

FIG. 5 shows an E7 alignment on negative pattern of C₃₀-PDMS₃₀-C₃₀ on glass. The liquid crystal is homeotropically aligned in black regions where was printed and parallel aligned in the 15 μm wide features where siloxane was not printed.

1. A method of applying a patterned thin-film onto a substrate comprising the steps:
i) plasma treating the substrate;
ii) applying a liquid coating material, comprising one or more compounds selected from the group of organopolysiloxane polymers, organopolysiloxane oligomers, siloxane resins and polysilanes, onto the substrate surface by a soft lithographic printing technique to form a patterned thin-film thereon; and
iii) where required, removing residual liquid coating material from the substrate surface;
which process does not require the liquid coating material undergo a curing step.

2. A method of applying a patterned thin-film in accordance with claim 1 wherein the resulting patterned thin-film has a thickness in the region of from 1 to 100 nm.

3. A method of applying a patterned thin-film in accordance with claim 1 wherein step (i) is carried out utilising a suitable source selected from the group of an atmospheric pressure glow discharge source, a dielectric barrier discharge (DBD) source, a low pressure glow discharge or post discharge plasma source, a corona discharge source and/or a microwave discharge source.

4. A method of applying a patterned thin-film in accordance with claim 1 wherein the substrate to be coated is selected from metals, metal foils metal oxides, glass, carbonaceous materials, ceramics, semi-conductor materials, plastics, liquid crystals, polymeric silicon containing materials, cellulosic materials, laminates and/or photoresist materials.

5. A method of applying a patterned thin-film in accordance with claim 1 wherein the substrate is pre-treated.

6. A method of applying a patterned thin-film in accordance with claim 5 comprising the step of pretreating the substrate by introducing an atomised liquid and/or solid coating-forming material into an atmospheric pressure plasma discharge and/or an ionised/excited gas stream resulting therefrom, and exposing the substrate to the atomised coating-forming material under conditions of atmospheric pressure.

7. A method of applying a patterned thin-film in accordance with claim 1 wherein the organopolysiloxane polymers/oligomers comprise a linear, branched or cyclic organopolysiloxane or copolymers thereof or a low molecular weight silicone resin in a liquid or wax form.

8. A method of applying a patterned thin-film in accordance with claim 7 wherein the linear or branched organopolysiloxane polymers/oligomers have a general formula:
W-A-W
where A is a polydiorganosiloxane chain having siloxane units of the formula R″ₛSiO _{4-s/2} in which each R″ independently represents an alkyl group having from 1 to 40 carbon atoms, an alkenyl group, hydrogen; an aryl group, a halide group, an alkoxy group, an epoxy group, an acryloxy group, or an alkylacryloxy group, s has a value of 0, 1 or 2; and
W is selected from —Si(R″)₂X, or
—Si(R″)₂—(B)_{d}—R″′SiR″ₖ(X)₃₋ₖ
where B is —R″′—(Si(R″)₂—O)ᵣ—Si(R″)₂— and
R″ is as aforesaid, R″′ is a divalent hydrocarbon groups r is zero a whole number between 1 and 6 and d is 0 or a whole number, X is the same as R″ or a hydrolysable group.

9. (canceled)

10. (canceled)

11. A method of applying a patterned thin-film in accordance with claim 1 wherein the soft lithographic printing technique is micro contact printing (μCP).

12. A method of applying a patterned thin-film in accordance with claim 1 wherein subsequent to application of the liquid coating material, the patterned thin-film on the substrate is at least partially further plasma treated and/or an additional coating is applied to form a second layer on the patterned thin-film.

13. A method in accordance with claim 1 wherein the method is carried out in a continuous process.

14. Use of a process method in accordance with claim 1 wherein the patterned thin-film is utilised to modify the surface alignment of a liquid crystal.

15. A method in accordance with claim 12 wherein the additional coating is applied to form the second layer using a soft lithographic printing technique.

16. Use of a method in accordance with claim 1 wherein the patterned thin-film is utilised as hydrophobic tracks to control material placement during subsequent processing

17. (canceled)

18. A method for modifying the alignment of a liquid crystal comprising applying a thin film onto a substrate surface in accordance with claim 1 such that the alignment of the liquid crystal is modified.

19. A substrate comprising a thin film applied in accordance with the method of claim 1.

20. A coated substrate obtainable by the method in accordance with claim 1.

21. A method in accordance with claim 1 wherein a region of the substrate surface is masked to substantially prevent or inhibit further physical or chemical changes to the previously uncoated, partially coated or fully coated substrate surface during a process step.
